(19) United States
(12) Patent Application Publication
(10) Pub. No.: US 2002/0026636 A1
(43) Pub. Date: Feb. 28, 2002

(54) Video interfacing and distribution system and method for delivering video programs

(76) Inventor: Daniel LeComte, Paris (FR)

Correspondence Address: THOMAS CHRISTENBURY, Schnader Harrison Segal & Lewis LLP, Suite 3600, 1600 Market Street, Philadelphia, PA, 19103, US

(21) Appl. No.: 09/881,075

(22) Filed: Jun. 14, 2001

Related U.S. Application Data
(60) Provisional application No. 60/211,590, filed on Jun. 15, 2000.

(51) Int. Cl. H04N 7/167; G06F 3/00; G06F 13/00; H04N 5/445

(52) U.S. Cl. 725/31; 725/38; 348/37; 348/133; 348/134

(57) ABSTRACT

The invention concerns a video interfacing arrangement for connecting at least one display device to at least one video source composed of a module including a dedicated and programmed digital processing unit adapted to decode and descramble video flow according to a preloaded decoding or descrambling program, in order to display, in real time or delayed in time, to store, to record and/or to send over a telecommunication network, and on at least one screen interface, at least one storage or recording interface, a local or wide area network connecting interface and a user communication and controlling interface, the interfaces being linked to and driven by the processing unit and preferably mounted in or on the module. The invention also concerns a distribution system and a method for transferring encoded video programs and sequences over a wide area network.

### RELATED APPLICATION

This application claims priority of U.S. Provisional Application No. 60/211,590, filed Jun. 15, 2000.

### FIELD OF THE INVENTION

This invention is concerned with handling of video data and television programs, or more generally any multimedia program or sequence, to authorized users and includes a video interfacing arrangement, a video distribution or delivering system and a method for delivering video or interactive multimedia programs and/or sequences.

### BACKGROUND

It has been a problem to provide a device able to interconnect various video or multimedia data displays and communication devices, which is simpler than a PC, can use a television screen as interactive display device, preserves the remote control functionality to which the television viewer is used and allows restricted and controlled broadcasting of prepaid video sequences or interactive programs.

It has also been a problem to provide a system for linking video or multimedia documents providers to subscribers and a method for transferring in a secured way such documents from one to the other, as well as to allow total control of the use of copies and the rights to access them.

### SUMMARY OF THE INVENTION

This invention relates to a video interfacing apparatus for connecting at least one display device to at least one video source including a module including a dedicated and programmed digital processor adapted to decode and descramble a video flow according to a preloaded decoding or descrambling program, in order to display, in real time or delayed in time, store, record and/or send the video flow over a telecommunication network, and at least one screen interface, at least one storage or recording interface, a local or wide area network connecting interface and a user communication and controlling interface, the interfaces being linked to and driven by the processor.

The invention also relates to a distribution system for transferring encoded video programs and sequences over a wide area network towards authorized users or system subscribers for display under selected conditions on adapted screens including one or more multimedia servers for collecting and storing at least video programs and sequences, each of the multimedia servers being connected, directly or via a portal or gate server and/or an access network, to the wide area network, and a plurality of video interfacing arrangements also linked to the wide area network and installed at a users' home(s) or at predetermined locations, each video interfacing arrangement being associated with at least one television screen type display device.

The invention also relates to a method for delivering video programs and/or sequences collected by and/or stored in adapted multimedia servers through a wide area network to authorized users provided with apparatus including addressing a concerned multimedia server or an associated portal server through the wide area network and ordering transfer of one or several given video program(s) or sequences(s) to an identified video interfacing arrangement also connected to the wide area network for immediate display or for at least partial storage and delayed display, checking the user's authorization at the concerned portal server and, if the case occurs, preloading an adapted transfer protocol and/or decode or descramble software from the portion server towards the video interfacing arrangement, transferring the ordered program(s) and/or sequences(s) associated with identity, security, cryptographic and/or handling restriction information preceding or entangled with the video data flow, and displaying, transferring, recording or handling in another way the transferred video program(s) and/or sequence(s) upon user's instructions, after checking identity of the user and rights, in accordance with possible handling restrictions.

### BRIEF DESCRIPTION OF THE DRAWINGS

The invention will be better understood according to the following description explaining the physical basis of the invention and based on the enclosed drawings showing a preferred embodiment of the latter as a non-limitative example of implementation.

In the enclosed drawings:

FIG. 1 is a block diagram of a video interfacing arrangement according to the invention, and

FIG. 2 is a block diagram of a distribution system according to the invention, including at least one arrangement as shown in FIG. 1.

### DETAILED DESCRIPTION

It will be appreciated that the following description is intended to refer to specific embodiments of the invention selected for illustration in the drawings and is not intended to define or limit the invention, other than in the appended claims.

In accordance with this invention, the above problems are solved by the provision of a video interfacing arrangement for connecting at least one display device, for example, a television screen type device, to at least one video source, characterized in that it is composed of a module mainly including, on the one hand, a dedicated and programmed digital processing unit adapted to handle, especially to decode and to descramble any type of video flow according to a preloaded decoding or descrambling program, in order to display it, in real time or delayed in time, to store it, to record it and/or to send it over a telecommunication network, and on the other hand, at least one screen interface, at least one storage or recording interface, a local or wide area network connecting interface and a user communication and controlling interface, the interfaces being linked to and driven by said processing unit and preferably mounted in or on said module.

Advantageously, the storage or recording interface(s) comprise(s) a hard disk interface and/or an analog or digital video recorder interface, such as a video cassette recorder interface, a CD recorder or a DVD recorder.

According to a particular embodiment, the screen interface(s) comprise(s) a standard wire connection screen interface and/or a wireless screen interface and wherein the user communication and controlling interface consists of a remote control interface, such as a wireless joystick, a wireless keyboard or any device using wireless technology such as infrared or UHF.

The module may also include at least one so-called “smart” card or credit card style memory card reader interface and/or a video camera interface for connecting at least one local camera, transmission links with distant webcams being possible through the network connecting interface.

In another embodiment, the network connecting interface is linked to a wide area network, directly or through a local area network forming an access network, and consists of a digital subscriber line interface, such as a modem or a cable interface, of an optical fiber line interface or of an air interface for radio communication.

According to a particular embodiment, the module, preferably including all the interfaces, constitutes an independent device mounted in a corresponding protective box.

Advantageously, the module, and preferably all the interfaces, are mounted inside a television set, on the electronic control card of the television or at least partially on a separate card, the dedicated digital processing unit preferably consisting of a monoprocessor or media processor and/or being identical with the television processor.

The invention also concerns a distribution system for transferring encoded video programs and sequences over a wide area network towards authorized users or system subscribers for display under given conditions on adapted screens, characterized in that it is mainly comprised of, on the one hand, one or several multimedia servers, collecting and storing at least video programs and sequences and each connected, directly or via a portal or gate server and/or an access network, to the wide area network and, on the other hand, a plurality of above video interfacing arrangements, also linked to the wide area network, and installed at the users' homes or at predetermined locations, each video interfacing arrangement being associated to at least one television screen type display device.

According to a particular embodiment of the distribution system, at least one multimedia server is associated with telecommunication or broadcast reception means and that at least one multimedia server is connected to directly access the wide area network.

Advantageously, the multimedia server(s) and/or the portal server(s) comprise means to encode and scramble video data, especially means to add and entangle cryptographic and security information at the beginning and along the sequences, such as a video degrading algorithm decreasing the picture quality upon unauthorized viewing, copying or reviewing of a sequence.

Preferably, the multimedia server and/or the portal server comprises a preloaded decoding or descrambling software stored in its memory.

The invention also concerns a method for delivering video programs and/or sequences collected by and/or stored in adapted multimedia servers through a wide area network to authorized users provided with above arrangements, comprising the steps of:

addressing the concerned multimedia server or an associated portal server through the wide area network and ordering the transfer of one or several given video program(s) or sequence(s) to an identified video interfacing arrangement also connected to said wide area network for immediate display or for at least partial storage and delayed display;

checking the user's authorization at the concerned portal server and, if the case occurs, preloading an adapted transfer protocol and/or decode or descramble software from the portal server towards said video interfacing arrangement;

transferring the ordered program(s) and/or sequence(s) associated with identity, security, cryptographic and/or handling restriction information, preceding or entangled with the video data flow;

displaying, transferring, recording or handling in another way the transferred video program(s) and/or sequence(s) upon user's instructions, after checking of his identity and rights, in accordance with possible handling restrictions.

Advantageously, the handling restrictions comprise limitations selected from the group consisting of maximum number of viewing, maximum local storage time, fixed display time, uninterrupted display, absence of rewind and/or forward features and no copying possibility.

According to a particular solution of the invention, the preloaded decode or descramble software is:

integrated within the video content

or automatically sent to the video interfacing arrangement

or sent to the video interfacing arrangement only on request.

Preferably, a portal server keeps a small part of the multimedia content, so that not all the information needed to watch the content is stored on the hard disk, in order to prevent illegal copy of the content, and in that the video interfacing arrangement needs to connect to the portal server in order to get the remaining information to be able to display the multimedia content.

For a MPEG or MPEG like stream, this small part of information consists of some or all of the I pictures. The portal exchanges some or all of the I pictures in the stream sent to the video interfacing arrangement, and that the small information kept on the portal server consists of the information needed to restore the real order of I pictures, or may use a combination of the methods.

Preferentially, the program restoring the real order of the I pictures is partially stored in the portal server. Advantageously, that the program restoring the real order of the I pictures is totally stored in the portal server. Also advantageously, the program restoring the real order of the I pictures is executed in the module.

The program restoring the real order of the I pictures may be executed in the portal server. The program restoring the real order of the I pictures is advantageously executed in partially in the module, and partially in the portal server.

According to a particular embodiment, the missing I images are sent with a high level of security, being scrambled by a dedicated algorithm in the portal server to prevent any illegal copying of these I images.

For a given multimedia content, the content is sent only once to the portal server, which then sends it to all interested modules.

The portal server may store part or all of the multimedia content, to be able to send it to any module without having to ask it to the multimedia server.

The module may also store part or all of the multimedia content on the hard disk, so that it doesn't need to stop the incoming stream whenever the user wants to pause, or to ask again for a previous content. The portal server may decide that the module stores the multimedia content on the hard disk.

The multimedia server may decide that the module stores the multimedia content on the hard disk. The module itself may decide to store the multimedia content on the hard disk.

According to a specific embodiment, when establishing a certified connection between a receiving device and a multimedia server, the receiving device transmits an identifier specific to it to the portal server, the portal server then determines the address corresponding to the identifier received, the portal server having stored in its memory every identifier of authorized receiving devices with their corresponding physical address, the portal server calling then the device located at the address corresponding to the identifier received.

The completion of an additional step where the portal server asks its identifier to the called back receiving device and the confirmation that this receiving device is trying to establish a connection with this calling portal server.

According to another specific embodiment the module can also be used as a server for delivering interactive video programs and/or sequences collected by and/or stored in its memory or hard disk.

The module can deliver its contents directly or via a portal or gate server and/or an access network, through a wide area network to authorized users equipped with another module.

Advantageously, the portal or gate server is used as a controller for the contents which are to be delivered by the module. Supervised by the application server, the portal or gate server can authorize or not the delivery of such content from the module.

Turning now to the drawings, a video interfacing arrangement 1 is adapted to connect at least one display device, for example, a television screen type device 2, to at least one video source 3, 5, 11, 12, 14.

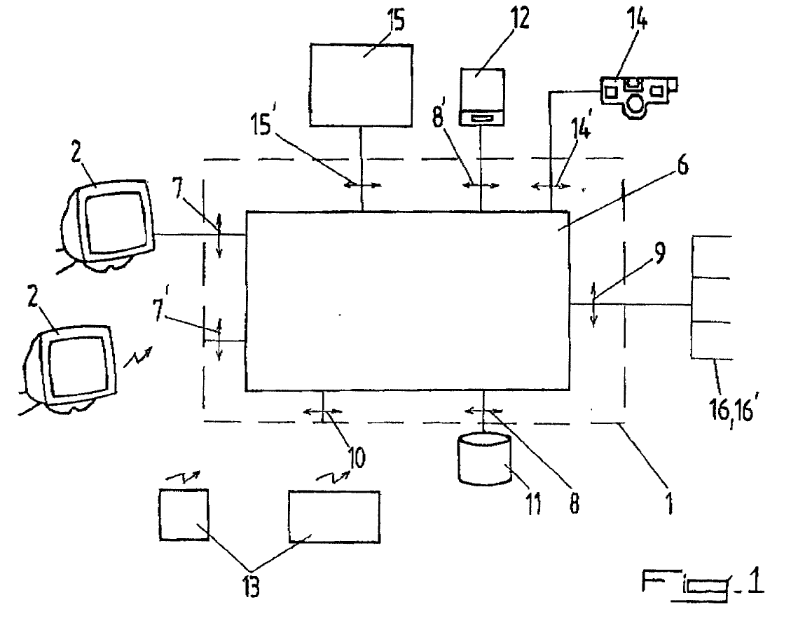

According to the invention, this arrangement is composed of a module 1 mainly including, on the one hand, a dedicated and programmed digital processing unit 6 adapted to handle, especially to decode and to descramble any type of video flow according to a preloaded decoding or descrambling software program, to display it, in real time or delayed in time, to store it, to record it and/or to send it over a telecommunication network, and on the other hand, at least one screen interface 7, 7′, at least one storage or recording interface 8, 8′, a local or wide area network connecting interface 9 and a user communication and controlling interface 10. Interfaces 7 to 10 are linked to and driven by processing unit 6 and preferably mounted in or on module 1 (FIG. 1). Preloaded decoding or descrambling software program can be integrated within the video content, can be sent automatically by the multimedia server 3, the portal server 4, or can be sent on request by the module 1.

The storage or recording interface(s) may comprise a hard disk 11 interface 8 and/or a video recorder interface 8′, such as an interface for a analog or digital video cassette recorder 12, a CD recorder or a DVD recorder.

The hard disk 11 can be used as a buffer to store temporarily at least a part of the video program or sequence to be displayed, in case of delayed viewing or transmission bandwidth limitations. Viewing may be delayed because of the user or the portal server.

The screen interface(s) may comprise a standard wire connection screen interface 7 and/or a wireless screen interface 7′ and the user communication and controlling interface 10 may consist of a remote control 13 interface. The remote control may be, for example, a joystick, a wireless keyboard, and may use any wireless technology, such as infrared or UHF communications.

In order to be able to store and display the user's own video sequences, the module 1 can include a video camera interface 14′ for connecting at least one local camera 14 transmission, links with distant webcams being possible through the network connecting interface 9.

According to an other feature of the invention, the module 1 can also be used as a server for delivering interactive video programs and/or sequences collected by and/or stored in its memory or hard disk 11. The module 1 can deliver its contents directly or via a portal or gate server 4 and/or an access network 16′, through a wide area network 16 to authorized users equipped with another module 1. The advantage of this solution is to use the portal or gate server 4 as a controller for the contents which are to be delivered by the module 1. Supervised by the application server, the portal or gate server 4 can authorize or not the delivery of such contents from the module 1.

According to another feature of the invention, the module 1 also integrates at least one so-called “smart” card or credit card style memory card reader 15 interface 15′, which enables the said module 1 to identify the user and to determine his access rights (to receive and play some multimedia content category).

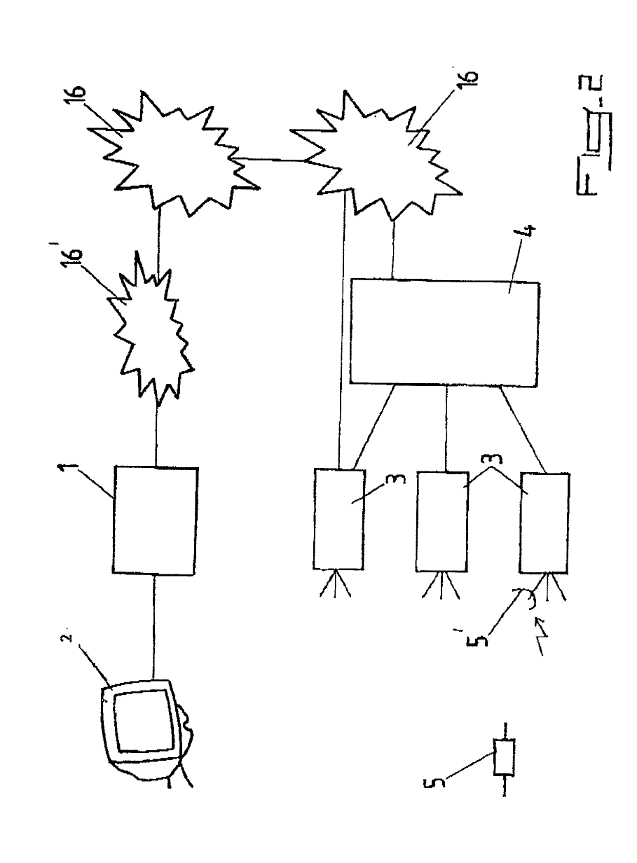

As shown in FIGS. 1 and 2 of the drawings, the network connecting interface 9 is linked to a wide area network 16, directly or through a local area network 16′ forming an access network, and consists, for example, of an digital subscriber line interface (DSL), such as a modem, a cable modem, of an optical fiber line interface or of a radio or IR interface for wireless communication.

The module 1 can integrate or not the DSL modem 9. If it is not integrated, the link between the module 1 and the DSL modem 9 can be anything from wired Ethernet, USB, FireWire (iLink 1394), power line, or any wired or wireless interface.

The module 1 is able to decode and descramble any video flow coming from an optional local camera 14, from the access network 16′ or from the local memory which could be a hard disk 11. As an option, the module 1 can decode two or more incoming sources at the same time and display them in two or more windows on the same screen, or on two or more different screens. These two or more windows can be sized upon user request and can be swapped in size and position.

The module 1 is also able to display, over the decoded picture(s), some graphic information to guide the user. At the same time or not, some graphic information can be highlighted upon user request, for example, to inform the user about the selected option which can be validated when the user presses the “OK” button of the remote control or remote control keyboard 13.

The module 1 is also able to store any incoming data information and at the same time to decode (transcode if necessary), descramble and display any information coming from any connected source (network, camera, or local memory).

According to one embodiment of the invention, shown in FIG. 1, the module 1, preferably including all the interfaces 7 to 10, 14′ and 15′, constitutes an independent device mounted in a corresponding protective box.

According to another embodiment, the module 1, and preferably all the interfaces 7 to 10, 14′ and 15′, are mounted inside a television set 2, on the electronic control card of said television set or at least partially on a separate card, the dedicated digital processing unit 6 preferably consisting of a monoprocessor or media processor and/or being identical or in place of the television set processor.

The digital processing unit 6 may be a multimedia processor such as, for example, the one known as TRIMEDIA from PHILIPS or one known as MAP-CA from EQUATOR, or a DSP (digital signal processor).

The protective box or the television set could also integrate, in addition to the interfaces (the structures and transmission protocols of which are known by the person skilled in the art), some of the peripheral equipment connected to these interfaces, such as the hard disk unit 11, the smart card reader 15 or others.

This invention also concerns the physical device used by the customer to access the data. This physical device is located in the end-user's home. It provides a set of functionalities, which manage the relevant information to be presented accordingly to the audience selection, and manages the connection and communication with the distant server.

All technical aspects such as login procedure, connection and communication with the distant server, URL address entry, and the like should be hidden to the user. A user-friendly interface and an intuitive mode of operation are important to a widely accepted product.

The physical device easily integrates in the customer's audio/video chain, without preventing previous functionalities. It is continuously connected to the audio-visual media through which it receives and sends information. It is as well continuously connected to traditional consumer devices such as a television set or a hi-fi equipment through which it presents the selected service. The device that was previously connected to the TV set is then chained to the physical device.

The physical device manages the user's subscription. A removable security device holds the corresponding current user's rights.

Two modes of operation are defined:

| | |
|---|---|
| Active: | the physical device processes data being received or recorded |
| | in accordance to user's request |
| Standby: | the physical device is monitoring external events triggering |
| | the transition to the active mode |

The physical device may be upgraded to add new functionalities or replace old ones. This is automatically done without user's participation.

The user can select a service among the possible choices corresponding to his subscription. No restrictions are made here. Operator services are to be handled by the physical device. The basic services include to name a few: on-line TV and Radio programs (broadcast), off-line TV event (recorded by the physical device), EPG, Internet access (Web browsing, email), and the like. The device can be served by one or more than one different service operators at the same time; each service operator being independent or not to the other ones.

The selection is achieved through a remote control device. All possible choices should be presented to the user, freeing him to enter complex and tedious information.

A subset of commands may be sent by the distant server allowing the user to access his physical device through other means like a WAP phone, for distant control such as scheduling the recording of an event.

When in active mode, the physical device obtains from the distant server the selected data components and processes them. When in standby mode, the physical device is still monitoring the audio-visual media, ready to respond to a distant command.

Connection and bi-directional communication with the distant server are completely handled by the physical device without user involvement other than the installation procedure.

The physical device relies on standards and/or proprietary formats for the communication with other equipment and for the processing of information. New standards and formats may be added or replace the current ones handled by the physical device, by an automatic upgrade.

The physical device has a bi-directional communication with the distant server. Received data are of several types:

| | |
|---|---|
| streaming data: | video, audio, and associated data involved in |
| | Richmedia presentations (e.g. HTML, SMIL, |
| | XML, Flash, ShockWave) |
| recording data: | video, audio, and associated data being recorded |
| | for later presentation |
| Internet data: | Web page transfer, file transfer (download), and |
| | the like |
| service data: | conditional access, physical device management |
| | data, alternate user control, and the like |
| Transmitted data | |
| are of several types: | |
| request conditionally | streaming data not recorded |
| accessible data: | |
| acknowledge: | streaming data acknowledge |
| Internet data: | Web server data acknowledge, file transfer to the |
| | portal server (upload) |
| streaming data: | video, audio, and associated data involved in |
| | Richmedia presentations (e.g. HTML, SMIL, |
| | XML, Flash, ShockWave) |
| recording data: | video, audio, and associated data being recorded |
| | for later presentation. |

The physical device offers the possibility to record and playback audio-visual components. The recording of a selected event can be scheduled by the user locally through the physical device remote control or remotely through operator services. The physical device offers the possibility to pause (time-shift) the current program for an undetermined period of time. Playback of a recorded event (either scheduled or time-shifted) offers fast forward, pause and rewind features.

Some recorded contents are protected against copying. In this case, the protection is active during playback as well as off line against a device trying to dub the recorded data.

Playback or streaming contents may be protected with an optional analog copy protection.

The physical device offers the possibility to access the Internet. Its embedded browser allows for Web surfing. Internet data can be downloaded and visualized later. Plug-ins can be supported as long as the physical device remains easy to use. Its embedded mailer allows the user to send and receive emails. E-mail attachments are supported when the format is handled by the physical device, like pictures, video, or audio.

The physical device supports a conditional access system based on a combination of a descrambling algorithm and a decryption device. As an option, the decryption device is removable.

An optional smart card reader allows banking transaction for services such as on-line purchase.

The physical device supports the following features:

Presentation of the relevant information corresponding to the service selected by the user

Management of the connection and the communication with the distant server

User-friendly interface and intuitive mode of operation

Insertion in user's audio-visual chain

User subscription management; removable security device

Two mode of operation: active and standby

Automatic upgrades

Service selection: audio-visual program or Internet contents

Local control of the physical device through a remote control device

Remote control of the physical device through operator services, with monitoring

Support of standards and/or proprietary formats for communication with other equipment and for information processing

Recording and playback of selected services

Time-shift of current program

Content protection

Web browsing; email with attachments

Recording of selected Internet data

Support of conditional access

Support of smart card for banking transaction

The physical device can be based on the main following elements:

The Application Processor (AP) which includes a general-purpose CPU, a memory controller, a graphics engine, a display controller, a general-purpose bus controller such as but not limited to a PCI bus controller, a general-purpose input/output controller, a digital video link such as but not limited to the CCIR-656 bus, an optional digital audio link such as but not limited to the I²S bus, a recording device controller such as but not limited to an IDE interface controller, an optional USB controller. As an example, the AP can be the Geode SC1200 from National Semiconductor.

The Media Processor (MP) which includes a dedicated engine for multimedia processing, a memory controller, a general-purpose bus controller such as but not limited to the PCI bus, a digital video link such as but not limited to the CCIR-656 bus, an optional digital audio link such as but not limited to the I²S bus. As an example, the MP can be the MAP-CA from Equator Technologies.

The two elements (the Application Processor (AP) and the Media Processor (MP)) can be integrated in only one physical processor called Media & Application Processor (MAP).

The internal recording device such as but not limited to an IDE hard disk drive.

The Ethernet controller which connects to the wide area network adapter such as but not limited to a DSL modem.

The USB controller which connects to the wide area network adapter such as but not limited to a DSL modem.

The required amount of memory for the AP and the MP and information storage and buffering.

The analog and/or digital audio and video interfaces connecting to the user display unit such as a TV set and/or a hi-fi equipment.

The front panel interfaces which includes the smart card controller, the remote control receiver, the front panel buttons and indicators.

The power supply.

The AP and MP exchange information using the following support:

Compressed or uncompressed audio/video and data using a fast local interconnection bus such as but not limited to a PCI bus.

Compressed or uncompressed video using a fast video bus such as but not limited to the CCIR-656 video port (VP).

Compressed or uncompressed audio using a fast local interconnection bus such as but not limited to the PCI bus or a specialized audio bus such as but not limited to an optional I²S port when available.

As an illustration, the processing of video and audio components follows these steps:

A/V packets are received in the Ethernet or the USB controller input buffer.

A/V packets are transferred by DMA to the AP RAM.

A/V packets are parsed by the A/V codec portion running on the AP.

Raw compressed A/V data are transferred by DMA to the MP RAM.

Raw compressed A/V data are processed by the A/V codec portion running on the MP.

Uncompressed video frames are transferred on the VP port from the MP to the AP.

Uncompressed audio frames are transferred on the I²S port from the MP to the AP.

Video frames are merged with the 2D graphics and output by the analog video interface.

Audio frames are merged with the PCM audio and output by the analog audio interface.

When audio and video components are recorded the raw compressed or uncompressed A/V data are transferred by DMA to the IDE controller.

When audio and video components are played back from the hard disk, compressed or uncompressed A/V data are transferred to the MP RAM to follow the normal processing.

The AP manages the USB host controller as well as the Front Panel controller.

The software of the physical device is built on the layer concept. The driver layer interfaces the hardware with the upper layers. This architecture allows for easy switching from one Operating System (OS) to another. The OS includes Real Time features to support uninterrupted audio and video play.

The physical device software relies on standards like TCP/IP, POP3 or HTTP to name a few. This architecture allows to choose applications, software components and tools from a large panel of products, and to easily develop specific applications.

Communication between the AP and the MP relies on an inter-processor communication protocol such as the Remote Procedure Call (RPC). This architecture allows easy movement to a single CPU solution when the product is available.

Some specific areas are under dedicated control:

The audio and video codecs, to benefit from the latest enhancement in compression technology.

The conditional access and access right management, to match customer's requirements.

As an illustration, the physical device integrates the following software modules:

Real Time OS

Audio decoders

Video decoders

Audio drivers

Video & Graphics management

Peripheral drivers (Ethernet, USB)

TCP/IP stack

File system & IDE driver

Conditional access

HTML browser, JavaScript, SSL

E-mail client

Video on demand application

EPG application

physical device manager application

This invention also concerns, as shown in FIG. 2, a distribution system for transferring encoded video or multimedia programs and sequences over a wide area network 16 towards authorized users or system subscribers for display under given conditions on adapted screens 2, characterized in that it is mainly comprised of, on the one hand, one or several multimedia servers 3, collecting and storing at least video programs and sequences and each connected, directly or via a portal or gate server 4 and/or an access network 16′, to the wide area network 16 and, on the other hand, a plurality of video interfacing arrangements 1 as described before, also linked to the wide area network 16, and installed at the users' homes or at predetermined locations accessible for the users, each video interfacing arrangement 1 being associated to at least one television screen type display device 2.

Preferably, at least one multimedia server 3 is associated with telecommunication or broadcast reception means 5′ and at least one multimedia server 3 is connected to directly access the wide area network 16. Thus, television programs broadcasted by VHF or satellite 5 can be transferred in real time via server 3 and network 16 on to the user's screens 2.

According to the invention, the multimedia servers 3 and/or the portal server(s) 4 comprise means to encode, transcode and scramble video data, especially means to add cryptographic and security information at the beginning and along the sequences, such as a video degrading algorithm decreasing the picture quality upon unauthorized viewing, copying or reviewing of a sequence.

At least one multimedia server 3 can be integrated within a portal server 4. Any number of multimedia servers can be connected to any portal server(s) and the number of portal servers 4 is not limited.

The portal server 4 offers Web and Internet standard capabilities to give access to any kind of multimedia information. It also verifies, manages and performs the subscription of any user who wants to be connected to any multimedia servers 3 part of the system or not.

A security interface 15′ can be provided as an option to the module 1. An internal or external smart card reader (SCR) 15 can be connected to the security interface 15′. It allows the user to be identified with a high security level. Any user can plug his smart card ID to any module 1. Consequently, the subscriber is identified by the portal server 4 and all the services will be provided through that module 1 activated by the user. That capability allows the user to be mobile and to have access to all its features any time and anywhere.

A user has to call the portal server 4 to perform the access to the relevant multimedia server 3. A menu is displayed on the local display screen 2. This menu can be provided either by the module 1 and/or by the portal server 4.

In one embodiment of the invention, this operation is a certification step, in order for the multimedia server 3 to be ensured that the calling module 1 is an authorized one. In this embodiment of the invention, every module 1 and every portal server 4 comprises in its memory a unique identification number (IN), such as a job number or a serial number, and a personal identification card (IC), which can be a smart card. The portal server 4 has access in its memory to every IN and every IC of every authorized calling device, every IC being associated with the physical address (in the telecom acceptation, such as an Internet Protocol address) of the corresponding calling device (identified thanks to the IC). As the module 1 calls the portal server 4, the module 1 transmits its IN and IC to the portal server 4. Then, the portal server 4 identifies in its memory the physical address corresponding to the IN and IC that have been transmitted, and calls the device located at this address stored in its memory, ignoring the address where the calling device was really located. If the calling device is an authorized one, then the address stored in the memory of the portal server 4 and the address where the calling device is located are the same, and the device that will be contacted by the portal server 4 is the device that has just transmitted its IN and IC to the portal server 4. When the portal server 4 calls back the calling device, the portal server 4 requests the IN and IC of the module 1, as well as a confirmation that the module 1 has just contacted the portal server 4. Then, if the INs and ICs are the same, and if the module 1 confirms that it has just requested a connection, the identity of the calling module 1 is certified.

A symmetrical operation is completed when the portal server 4 tries to transmit data to the module 1: the module 1 calls back the portal server 4 to certify its identity. It is important to note that such a certification can be completed in a full duplex way, without the need to hang up the phone communication, since it is possible to have several communications simultaneously on a single line such as a Digital Subscriber Line.

After the user has been identified and a multimedia program has been selected, the portal server 4 asks the corresponding multimedia server 3 to send the data to the module 1. The selected multimedia program can also be sent directly from the multimedia server 3 to the module 1 under the portal server 4 request. The data can be scrambled either by the multimedia server 3 and/or by the portal server 4. The descrambling is preferably done by the module 1 only when the data are displayed on the screen. This offers a high level of data security and prevents the multimedia data (for example, a video movie) to be copied on any other device which is not compatible with the module 1 technology and protocols.

Although the invention is more particularly directed to video data, it should be understood that any interactive multimedia information and interactive data could be handled by the present arrangement and system, the video-data being the more elaborated one.

The interactive multimedia data servers 3 can store any kind of interactive multimedia program such as movies, TV films, news, advertising, etc. All these programs are stored in a digital form of any kind of standards which are available today (such as MPEG-1, MPEG-2, MPEG-4, MPEG-7, Windows MediaVideo®, Quick Time®, Real Video®, DivX, etc.) or any coming standards based on new and future technologies such as wavelets or fractals.

The digitization of these programs and/or the coding of these programs can be performed off-line before the storage, or on-line thanks to the implementation of coders in the multimedia server 3 and/or the portal server 4. With that feature, it is also possible to connect real time program providers to the multimedia server 3. These real time program providers are the cable TVs, the satellite TVs and any TV providers.

In order to prevent copying of a program or sequence in a digital form, a cryptographic information can be added at the beginning and along the program.

An example is the “Unicast” protocols, wherein picture quality is decreased thanks to a degrading algorithm. This degrading algorithm is introduced when the program is sent by the portal server 4 or the multimedia server 3 and the subscriber reference is also added at the beginning and along the program. When the user (subscriber) wants to see this program, he has to introduce his smart card. The module 1 verifies if the user has the right to see it. This verification can be done through the network link 16′-16-16′-9 by the portal server 4. If the answer is positive, the program is displayed with the right picture quality. Otherwise, the program is displayed with the decreased picture quality. The degrading quality can be seen on a PC (free of charge).

According to another embodiment of the invention, all the data might not be sent from the multimedia server to the physical device. Hence requiring the physical device to be connected to the portal server while actually watching the multimedia data. This prevents illegal copying of the data.

This embodiment of the invention is achieved through the following mechanism. When a multimedia content is to be transferred from a multimedia server (3, 5) to the hard drive (11) of the physical device (1), it goes through a portal server (4). This one then keeps small parts of the multimedia content. Those parts are chosen all along the multimedia content stream in such a way that, while being small in size, not having those parts really prevents watching the multimedia content. Those parts of the content are then transferred to the physical device (1) only when the user actually watches the data. Those parts are never stored on the hard drive (11). Those parts are transferred each time the user wants to watch the data again.

If a given multimedia content is to be transferred to different users, the way the portal server (4) keeps those parts is different for every user. Those “personalized coding methods” are then transferred to every user physical device (1), so that the device can retrieve the original content when receiving the missing parts. For improved security, those coding methods can be fully or partly computed in the physical device (1) and/or the portal server (4).

Each time the user wants to watch the multimedia contents, the physical device (1) automatically connects to the portal server (4) to get the missing parts.

This way, the content provider is informed each time a given user watch a multimedia content, and hence permits an accurate control over copy management and copy protection.

This method ensures that nobody can watch the multimedia content without being connected first to the portal server 4. This connection is automatically established by the module 1, without any intervention of the user, and every time the multimedia content is being watched. Thus, it is possible for the portal server 4 to check if the user has effectively the authorization to watch the multimedia content every time this multimedia content is being watched.

According to this method, the module 1 transmits systematically an information representative of the user every time the user wants to watch the multimedia content, which allows a total control on the use of the copies and the rights to access them (Copy Management & Copy Protection).

This automatic and permanent connection between the module 1 and the portal server 4 is made possible thanks to the bi-directional network 16 which can be of an xDSL type, or any type that allows such a permanent bi-directional connection.

An example of how this can be achieved through the MPEG file architecture or through any other video architecture using I types pictures is as follows. A MPEG video stream is composed of pictures I, B and P. The B and P kinds of picture highly depend on the I kind, while the I pictures are independent from each other and can be shown ‘as such’ on the screen.

A way to achieve the protection is to keep some or even the totality of these I images stored in the portal server 4. Simultaneously, it is possible to substitute false I images to some of the I images sent to the physical device and stored on the hard disk 11. This substitution is completed by a substitution program based on an algorithm specific to the module 1 where the data are sent. Simultaneously, it is possible to permute some of the I images sent to the physical device and stored on the hard disk 11. This permutation is completed by a permutation program based on an algorithm specific to the module 1 where the data are sent.

The program permuting the I images can be combined with the program substituting the I images kept stored in the portal server 4.

The substitution program and the permutation program can be stored on the hard disk 11, or kept stored in the portal server 4 and downloaded when needed.

The substitution program can be totally executed on the module 1 (client side), or totally in the portal server 4 (server side), or partially on the module 1 and partially in the portal server 4.

Independently, the permutation program can be totally executed on the module 1 (client side), or totally in the portal server 4 (server side), or partially on the module 1 and partially in the portal server 4.

This function permuting the I images can be combined with the function substituting the I images stored in the portal server 4.

Every time that a user wants to watch multimedia content, the module 1 automatically establishes a connection with the portal server which checks the authorization of the user before sending the missing I images.

It is also possible to associate a Copy Management & Copy Protection Program with the permuting function, this program being executed when the multimedia content is being watched. According to this method, the module 1 transmits systematically a message to the portal server 4 every time the user wants to watch the multimedia content, which allows a total control on the use of the copies and the rights to access them (Copy Management & Copy Protection).

Finally, the missing I images are sent to the module 1. They can be sent as such, or with a high level of security if they are scrambled by a dedicated algorithm in the portal server 4 to prevent illegal use of these I images.

This solution covers three aspects: first, there are less data stored on the portal server 4, second, it is possible to have a specific code for every single user, and finally, the user is forced to establish a connection with the portal server 4 every time he wants to watch the multimedia content. It is important to note that this forced connection is automatically established by the module 1.

According to this invention, it is possible to send a maximum amount of data from the multimedia servers 3 to the hard-disc 11 of the module 1 in a way that it is impossible for the user to display the program on his screen 2, 2′.

In contrast, in the prior art, the multimedia data corresponding to the totality of the movie are protected, and every multimedia content stored in a module 1 is coded in a different way than the same multimedia content stored in a different module 1.

This method can be used for multimedia contents coded in the MPEG format, as well as for multimedia contents coded in other formats as long as it is possible to insulate images similar to the I images, which means images describing the totality of the information or information important enough that another large amount of data of the stream depends on it, such as the Base Layer in the case of the wavelets, for example. These I images (I standing for Important), necessary for the multimedia content to be useable, are partially or totally stored in the portal server 4, and sent to the user after the certification of the authorization.

Also available are “Multicast” protocols which are quite equivalent to the first cited, except for the suppression of the subscriber reference, which is replaced by the Multicast information.

Other information can also be transmitted, at the beginning and/or along the video-program such as:

number of display (how many times this program can be seen: from 1 to n),

recording time: how long this program can be maintained in the module 1 (to be seen up the n times).

Features such as rewind, fast rewind, forward, fast forward are also available (or not).

The invention also concerns a method for delivering video programs and/or sequences collected by and/or stored in adapted multimedia servers through a wide area network to authorized users provided with arrangements 1 as mentioned above, characterized in that it comprises the steps of:

Addressing the concerned multimedia server 3 or an associated portal server 4 through the wide area network 16 and ordering the transfer of one or several given video program(s) or sequence(s) to an identified video interfacing arrangement 1 also connected to said wide area network 16 for immediate display or for at least partial storage and delayed display;

Checking the user's authorization at the concerned portal server 4 and, if the case occurs, preloading an adapted transfer protocol and/or decode or descramble program from said portal server 4 towards said video interfacing arrangement 1;

Transferring the ordered program(s) and/or sequence(s) associated with identity, security, cryptographic and/or handling restriction information, preceding or mixed with the video data flow;

Displaying, transferring, recording or handling in another way the transferred video program(s) and/or sequence(s) upon user's instructions, after checking of his identity and rights, in accordance with possible handling restrictions.

The handling restrictions can comprise limitations selected from the group consisting of maximum number of viewing, maximum local storage time, fixed display time, uninterrupted display, absence of rewind and/or forward features and no copying possibility.

The invention makes it possible for the provider to respect possible specific wishes of the authors of programs or sequences, such as for example no segmentation of the film or other multimedia work of art by the provider (no publicity cuts) and/or by the viewer (no interruption during display, suppression of the “pause” or “rewind” feature), limited temporary acquisition (self-erasure after a given storage time) or no possibility to transfer it outside the module 1.

Finally, the invention also concerns a method for using the module 1 as a server for delivering interactive video programs and/or sequences collected by and/or stored in the module 1 through a wide area network 16, 16′ to authorized users provided with arrangements 1 as mentioned above, characterized in that it comprises the steps of:

using module 1 as a server with characteristics equivalent to any server 3 or 5 by way of digital line 16, 16′,

the module 1 used as a server can push interactive video programs or sequences to any other module 1 through the digital network 16′,

any authorized users equipped with a module 1 can retrieve interactive video programs or sequences from any other module 1 used as a server.

As an illustrative example, the working of the system will now be described.

First, the user checks the menu on his TV screen using the remote control 13.

By selecting the program on the menu, he orders the module 1 to visualize the program. The module 1 asks the portal server 4 to retrieve the program from the corresponding multimedia server 3. Then the program is sent by the multimedia server 3 to the module 1 which decodes and displays it on the user's TV screen 2.

At the beginning of the process, before the program is sent from the multimedia server 3 to the module 1 under the control of the portal server 4, there is a preliminary exchange dialogue between the multimedia server 3 and the module 1 to verify which kind of decoding and/or descrambling software is available within the module 1. If the decoding and/or descrambling software is available within the module 1, the multimedia server 3 will serve the multimedia program immediately. Otherwise, the multimedia server 3 will ask the portal server 4 to send automatically a new and adapted decoding and/or descrambling software to the module 1 prior to sending the interactive multimedia program.

According to another embodiment of the invention, the portal 4 can also decide to send automatically a new and adapted decoding and/or descrambling software to the module 1.

According to another embodiment of the invention, the module 1 can also ask the portal 4 or the multimedia server 3 to send it a new and adapted decoding and/or descrambling software.

When arriving at the module 1, the video program informs the module 1 about the coding and/or scrambling algorithms it is based on, in order to execute the right decoding and/or descrambling software. The latter can also be sent automatically with the program or sequence to be displayed.

To summarize, the decoding and/or descrambling software can be integrated within the video content, can be sent automatically by the multimedia server 3, the portal server 4, or can be sent on request by the module 1.

However, the network can have (or not) bandwidth limitation. This limitation can jeopardize the quality of the picture if no solution is provided to solve this problem.

If the whole transmission link (from the server 3 to the module 1) is not affected by bandwidth limitation, then the multimedia program is directly sent by the multimedia server 3 to the module 1. That can also be accomplished through the portal server 4 or not.

The program is immediately displayed on the television screen 2. Any kind of VCR or DVD peripheral equipment or feature is under the control of the user by means of the remote control 13. These VCR and DVD features can be offered directly by the multimedia server 3/portal server 4 or by the module 1 which can use the local hard disk memory 11 to temporarily store the incoming program while the user does a pause, rewinds, etc.

In case the whole network (from multimedia server 3 to module 1) has bandwidth limitation or time constraints, the module 1 uses its hard disk memory 11 to locally temporarily store and buffer the beginning of the multimedia program. The length of this buffer depends on the quality of the whole network. The module 1 should be able to store the entire multimedia program.

The interactive multimedia program can also be displayed in a delayed time. In that case, the multimedia program is transferred (according to previous orders), at the network speed, from the multimedia server 3 to the hard disk memory 11 of the module 1 with the possible condition to be completely transferred before a given time. Later, this program will be extracted from the hard disk memory 11 as requested by the user. All VCR and DVD features are still available during the visualization of the program.

By using any Web compatible device (WebPhone, PC, WAP phone, etc.) connected to the Web, a user can ask the portal server 4 to send a multimedia program to his module 1.

A subscriber can be located anywhere in the world and use any Web device to connect himself to a portal server 4 of the system. By using adapted security procedures, he is recognized by the portal server 4 as a correct subscriber and can order any multimedia program from any multimedia server 3 to be downloaded to his module 1 (the module of the place he is in).

The multimedia program is then sent to his module 1 and stored in the hard disk 11. Depending on the size of the hard disk 11, large number of interactive multimedia programs can be stored and/or remotely ordered.

As indicated before, a smart card can be used to identify the user and check that the subscriber order is accepted by its Service provider. As an option, prepaid smart cards are available. This offers the capability for a user to utilize his card to buy some interactive multimedia program without being a permanent subscriber (similarity with mobile phone subscribers).

Any user can have full access to the Internet and the Web through the module 1, using the TV screen and the remote control 13.

The invention also concerns a method for optimizing the streaming between the server 3 and the video interfacing arrangement 1, through the portal server 4. The method is thought to enable some kind of multicast streaming on networks that don't have this capability. The data stream is pushed from the server 3 to the portal server 4 (using broadcast, unicast or multicast). The portal server 4 acts as a video interfacing arrangement 1 with respect to the server 3. Then, the portal server 4 acts as a server with respect to some or all the video interfacing arrangement 1 which connects to it. The aim is to reduce the stress on the server 3 and reduce the bandwidth used on the network, while at the same time, offering a Quality of Service to the real video interfacing arrangements 1.

The portal server 4 can record part or all of the streaming content to deliver part or all of the stream to another video interfacing arrangement 1 later on. The video interfacing arrangements 1 usually also records the streaming content on their hard disk 11 to reduce the bandwidth used on the network. This way, if the user wants to pause (time-shift) the current program, there is no need for the multimedia content to be sent through the network: the video interfacing arrangement 1 asks the portal server 4 which asks the server 3. If the video interfacing arrangement 1 is authorized to keep on displaying the content, the data is taken from its hard disk 11. If the video interfacing arrangement 1 wants to pull some content, it will asks the portal server 4 which may then ask the server 3.

The server 3, the portal server 4 and the video interfacing arrangement 1 may all independently decide that the multimedia content should be stored on the hard disk 11 on the video interfacing arrangement 1. Each of them may decide upon different criterion such as the estimated audience of a program, the estimated success of a program, the statistics about a given user. For example, advertising content is usually widely diffused, and as such, storing it on the hard disk 11 will prevent this program to be sent several times. The portal server 4 has a mean to check if a given program is already stored on the video interfacing arrangement 1, to prevent the portal server 4 to send it again.

The invention is not limited to the preferred embodiment described herein and shown on the enclosed drawings, changes can be made or equivalents used without departing from the scope of the invention.

1. A video interfacing apparatus for connecting at least one display device to at least one video source comprising:
a module including
a dedicated and programmed digital processor adapted to decode and descramble a video flow according to a preloaded decoding or descrambling program, in order to 1) display, in real time or delayed in time, 2) store, 3) record and/or 4) send the video flow over a telecommunication network, and
at least one screen interface, at least one storage or recording interface, a local or wide area network connecting interface and a user communication and controlling interface, said interfaces being linked to and driven by said processor.

2. The apparatus according to claim 1, wherein the storage or recording interface(s) comprise(s) a hard disk interface and/or an analog or digital video recorder interface, selected from the group consisting of a video cassette recorder interface, a CD recorder and a DVD recorder.

3. The apparatus according to claims 1 or 2, wherein the screen interface(s) comprise(s) a standard wire connection screen interface and/or a wireless screen interface and wherein the user communication and controlling interface consists of a remote control interface selected from the group consisting of a wire and/or wireless joystick, a wire and/or wireless keyboard and any device using wire or wireless technology.

4. The apparatus according to claim 1, wherein the module also includes at least one smart card or credit card style memory card reader interface.

5. The apparatus according to claim 1, wherein the network connecting interface is linked to a wide area network, directly or through a local area network forming an access network, and consists of a digital subscriber line interface, or a cable interface, of an optical fiber line interface or of an air interface for radio communication.

6. The apparatus according to claim 1, wherein the module also includes a video camera interface for connecting at least one local camera, to facilitate transmission links with distant webcams through the network connecting interface.

7. The apparatus according to claim 1, wherein the module includes all the interfaces and is an independent device mounted in a corresponding protective box.

8. The apparatus according to claim 1, wherein the module, and the interfaces, are mounted inside a television, on an electronic control card of said television or at least partially on a separate card, the dedicated digital processor comprising a monoprocessor or media processor and/or being identical with a processor of the television.

9. A distribution system for transferring encoded video programs and sequences over a wide area network towards authorized users or system subscribers for display under selected conditions on adapted screens comprising:
one or more multimedia servers for collecting and storing at least video programs and sequences;
each of said multimedia servers being connected, directly or via a portal or gate server and/or an access network, to the wide area network, and
a plurality of video interfacing arrangements according to claim 1, also linked to the wide area network, and installed at a users' home(s) or at predetermined locations, each video interfacing arrangement being associated with at least one television screen type display device.

10. The distribution system according to claim 9, wherein at least one of the multimedia servers is associated with telecommunication or broadcast reception means and that at least one multimedia server is connected to directly access the wide area network.

11. The distribution system according to claim 9, wherein the multimedia servers and/or the portal server(s) comprise means to encode and scramble video data, including means to add and entangle cryptographic and security information at the beginning and along sequences thereof upon unauthorized viewing, copying or reviewing of a sequence.

12. The distribution system according to claim 11, wherein the multimedia server and/or the portal server comprises preloaded decoding or descrambling software stored in its memory.

13. A method for delivering video programs and/or sequences collected by and/or stored in adapted multimedia servers through a wide area network to authorized users provided with apparatus according to claim 9, comprising:
addressing a concerned multimedia server or an associated portal server through the wide area network and ordering transfer of one or several given video program(s) or sequence(s) to an identified video interfacing arrangement also connected to said wide area network for immediate display or for at least partial storage and delayed display;
checking the user's authorization at the concerned portal server and, if the case occurs, preloading an adapted transfer protocol and/or decode or descramble software from said portal server towards said video interfacing arrangement;
transferring the ordered program(s) and/or sequence(s) associated with identity, security, cryptographic and/or handling restriction information, preceding or entangled with the video data flow; and
displaying, transferring, recording or handling in another way the transferred video program(s) and/or sequence(s) upon user's instructions, after checking identity of the user and rights, in accordance with possible handling restrictions.

14. The method according to claim 13, wherein the handling restrictions comprise limitations selected from the group consisting of maximum number of viewing, maximum local storage time, fixed display time, uninterrupted display, absence of rewind and/or forward features and no copying possibility.

15. The method according to claim 13, wherein the preloaded decode or descramble software is integrated within the video content.

16. The method according to claim 13, wherein the preloaded decode or descramble software is automatically sent to the video interfacing arrangement.

17. The method according to claim 13, wherein the preloaded decode or descramble software is sent to the video interfacing arrangement only on request.

18. The method according to claim 9, further comprising a portal server which keeps a small part of multimedia content, so that not all information needed to monitor the content is stored on a hard disk to prevent illegal copying of the content, and in that the video interfacing arrangement connects to the portal server to get the remaining information to be able to display the multimedia content.

19. The method according to claim 18, wherein, for a MPEG or MPEG like stream, a small part of information in said stream consists of some or all of I pictures.

20. The method according to claim 18, wherein, for a MPEG or MPEG like stream, the portal exchanges some or all of the I pictures in the stream sent to the video interfacing arrangement, and small information kept on the portal server consists of information needed to restore the real order of the I pictures.

21. The method according to claim 18, wherein, for a MPEG or MPEG like stream, the portal server may use a) a small part of information in said stream consisting of some or all of I pictures and b) some or all of the I pictures in the stream sent to the video interfacing arrangement, and small information kept on the portal server that consists of information needed to restore the real order of the I pictures.

22. The method according to claim 20, wherein the program restoring the real order of the I pictures is partially stored in the portal server.

23. The method according to claim 20, wherein the program restoring the real order of the I pictures is totally stored in the portal server.

24. The method according to claim 20, wherein the program restoring the real order of the I pictures is executed in the module.

25. The method according to claim 20, characterized in that the program restoring the real order of the I pictures is executed in the portal server.

26. The method according to claim 20, wherein the program restoring the real order of the I pictures is executed partially in the module, and partially in the portal server.

27. The method according to claim 18, wherein missing I images are sent with a high level of security, being scrambled by a dedicated algorithm in the portal server to prevent copying of the I images.

28. The method according to claim 9, wherein, for a given multimedia content, the content is sent only once to the portal server, which then sends it to all interested modules.

29. The method according to claim 9, wherein the portal server may store part or whole of the multimedia content, to be able to send it to any module without having to query the multimedia server.

30. The method according to claim 9,wherein the module may store part or all of the multimedia content on a hard disk, so that need not stop the incoming stream whenever a user wants to pause, or to ask again for a previous content.

31. The method according to claim 30, wherein the portal server may decide that the module stores the multimedia content on the hard disk.

32. The method according to claim 30, wherein the multimedia server may decide that the module stores the multimedia content on the hard disk.

33. The method according to claim 30, wherein the module may decide to store the multimedia content on the hard disk.

34. The method according to claim 9, wherein, when establishing a certified connection between a receiving device and a multimedia server, the receiving device transmits an identifier specific to it to the portal server, the portal server then determines the address corresponding to the identifier received, the portal server having stored in its memory every identifier of authorized receiving devices with their corresponding physical address, the portal server then calling the device located at the address corresponding to the identifier received.

35. The method according to claim 34, wherein completion of an additional step where the portal server asks its identifier to the called back receiving device and the confirmation that this receiving device is trying to establish a connection with this calling portal server.

36. The method according to claim 9, wherein the module can also be used as a server for delivering interactive video programs and/or sequences collected by and/or stored in its memory or hard disk.

37. The method according to claim 36, wherein the module can deliver its contents directly or via a portal or gate server and/or an access network, through a wide area network to authorized users equipped with another module.

38. The method according to claim 36, wherein the portal or gate server is a controller for contents which are to be delivered by the module.
